(19) United States
(12) Patent Application Publication
(10) Pub. No.: US 2002/0095233 A1
(43) Pub. Date: Jul. 18, 2002

(54) Distribution controlling apparatus and method and method for manufacturing semiconductor device

(75) Inventor: Hiroyuki Takeuchi, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 09/875,958

(22) Filed: Jun. 8, 2001

(30) Foreign Application Priority Data
Jan. 12, 2001 (JP) 2001-005461

(51) Int. Cl. G06F 19/00

(52) U.S. Cl. 700/121; 700/9; 700/215; 700/226

(57) ABSTRACT

A distribution controlling apparatus and method and a method for manufacturing a semiconductor device using the distribution controlling apparatus in which the current and last processes can be linked together and in which a system for controlling distribution can be easily operated. A reference in-process turnover for each group of manufacturing apparatuses enables a priority process request to be made to the last process so that a higher priority is given to those of a group of processed products being processed by the current group of manufacturing apparatuses which flow to a group of manufacturing apparatuses having an in-process turnover smaller than a reference in-process turnover during the next process. As a result, despite the control of the entire process in a factory, each group of manufacturing apparatuses are always prevented from waiting for products, thus enabling the capabilities of the manufacturing apparatuses to be maximized. Consequently, manufacturing periods and inventory properties can be reduced. Furthermore, the systemization serves to save labor and increase process speeds.

### BACKGROUND OF THE INVENTION

1. Field of the Invention

The present invention relates to a distribution controlling apparatus and method and a method for manufacturing a semiconductor device, and in particular, to a distribution controlling apparatus and method which controls the distribution of lots and a relevant method for manufacturing a semiconductor device.

2. Description of Related Art

If products are manufactured through a plurality of processing processes, the distribution of lots is conventionally controlled using a method based on a first-in first-out method or a quick-delivery-product interruption method. These conventional controlling methods determine or control the priority of the current process. Furthermore, different products to be manufactured require different process times to be registered.

Since the conventional methods determine or control the priority of the current process as described above, it has been difficult to link the current and preceding processes together. Furthermore, different products to be manufactured require different process times to be registered, thereby disadvantageously complicating the operation of a system for controlling distribution.

### SUMMARY OF THE INVENTION

It is thus an object of the present invention to provide a distribution controlling apparatus and method which is adapted to solve the above problem and which allows the current and preceding processes to be linked together to simplify the operation of a system for controlling distribution.

It is another object of the present invention to provide a method for manufacturing a semiconductor manufacturing device using the present distribution controlling apparatus.

According to a first aspect of the present invention, there is provided a distribution controlling apparatus comprising: a process flow recording section having identifiers of processed products and identifiers of manufacturing apparatuses recorded therein for each process, the manufacturing apparatuses processing the processed products; a reference in-process turnover recording section having a throughput and a reference in-process turnover of each manufacturing apparatus recorded therein for each process, the throughput being indicative of the amount of processed products that can be processed by a manufacturing apparatus during a predetermined period, the reference in-process turnover being indicative of a ratio between an in-process amount of a process and the throughput; an in-process data recording section having a lot number, an identifier of processed products in the lot, an in-process process for the lot, and a latest in-process amount during the in-process process recorded therein for each lot; latest in-process turnover calculating means for reading from the in-process data recording section the identifiers of processed products in lots which are in a predetermined in-process process, reading from the process flow recording section identifiers of manufacturing apparatuses corresponding to the identifiers of the processed products which are in the predetermined in-process process, adding the latest in-process amount to lots which are in the predetermined in-process process and which have the identifier of the same manufacturing apparatus, reading from the reference in-process turnover recording section the throughput corresponding to the identifier of the manufacturing apparatus operating during the predetermined in-process process, and dividing the latest in-process amount obtained through the addition, by the throughput to determine a latest in-process turnover; and priority request presenting means for reading from the reference in-process turnover recording section the reference in-process turnover corresponding to the identifier of the manufacturing apparatus operating during the predetermined in-process process, and if the latest in-process turnover determined by the latest in-process turnover calculating means is smaller than the reference in-process turnover, presenting a priority process request for lots which are in a process before the predetermined in-process process and for which the manufacturing apparatus is used during the predetermined process.

According to a second aspect of the present invention, there is provided a distribution controlling method using: a process flow recording section having identifiers of processed products and identifiers of manufacturing apparatuses recorded therein for each process, the manufacturing apparatuses processing the processed products; a reference in-process turnover recording section having a throughput and a reference in-process turnover of each manufacturing apparatus recorded therein for each process, the throughput being indicative of the amount of processed products that can be processed by a manufacturing apparatus during a predetermined period, the reference in-process turnover being indicative of a ratio between an in-process amount of a process and the throughput; and an in-process data recording section having a lot number, an identifier of processed products in the lot, an in-process process for the lot, and a latest in-process amount during the in-process process recorded therein for each lot, the method comprising the steps of: a latest in-process turnover calculating step of reading from the in-process data recording section the identifiers of processed products in lots which are in a predetermined in-process process, reading from the process flow recording section identifiers of manufacturing apparatuses corresponding to the identifiers of the processed products which are in the predetermined in-process process, adding the latest in-process amount to a lot which is in the predetermined in-process process and which has the identifier of the same manufacturing apparatus, reading from the reference in-process turnover recording section the throughput corresponding to the identifier of the manufacturing apparatus operating during the predetermined in-process process, and dividing the latest in-process amount obtained through the addition, by the throughput to determine a latest in-process turnover; and a priority request presenting step of reading from the reference in-process turnover recording section the reference in-process turnover corresponding to the identifier of the manufacturing apparatus operating during the predetermined in-process process, and if the latest in-process turnover determined by the latest in-process turnover calculating step is smaller than the reference in-process turnover, presenting a priority process request for lots which are in a process before the predetermined in-process process and for which the manufacturing apparatus is used for the predetermined process.

According to a third aspect of the present invention, there is provided a method for manufacturing a semiconductor device, the method using the distribution controlling apparatus set forth in any of the present invention (claims 1 to 5).

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows the configuration of a distribution controlling apparatus or system according to an embodiment of the present invention.

FIG. 2 shows the contents of the process flow recording section 3 shown in FIG. 1.

FIG. 3 shows the contents of a combination of the apparatus data recording section 4 and reference in-process turnover recording section 6 shown in FIG. 1.

FIG. 4 shows the contents of the in-process data recording section 5 shown in FIG. 1.

FIG. 5 is a flow chart showing a distribution controlling method according to the embodiment of the present invention.

### DETAILED DESCRIPTION OF THE PREFERRED EMBODIMENTS

An embodiment of the present invention will be described below with reference to the drawings.

FIG. 1 shows the configuration of a distribution controlling apparatus or system according to an embodiment of the present invention. This distribution controlling apparatus or system can be configured using computers. In FIG. 1, reference numeral 1 denotes an information processing section for determining the priority of a product process and executing other processes, reference numeral 2 denotes a recording section for recording process flow information, device data, in-process data, and reference in-process turnover (described later) information, which are all required for controlling distribution, reference numeral 10 denotes an input section for inputting data or the like to register or change the various data or the like which are recorded in the recording section 2 and required for information processing for distribution control, reference numeral 11 denotes a display section for displaying results of a process executed by the information processing section 1, reference numeral 12 denotes a conveying device for automatically conveying processed products from a group of processed products to a manufacturing apparatus 13 based on the results of the process executed by the information processing section 1, and reference numeral 13 denotes the manufacturing apparatus for processing processed products. The recording section 2 comprises four files constituting a process flow recording section 3 having the name of products and the manufacturing apparatus 13 used for each process recorded therein, an apparatus data recording section 4 having a throughput and others recorded therein, the throughput being indicative of the amount of processed products that can be processed by the manufacturing apparatus 13 during a predetermined period, an in-process data recording section 5 having an in-process process, an in-process amount, and others recorded therein for each lot, and a reference in-process turnover recording section 6 having a reference in-process turnover and others recorded therein, the reference in-process turnover being indicative of a ratio between the in-process amount and throughput of the process.

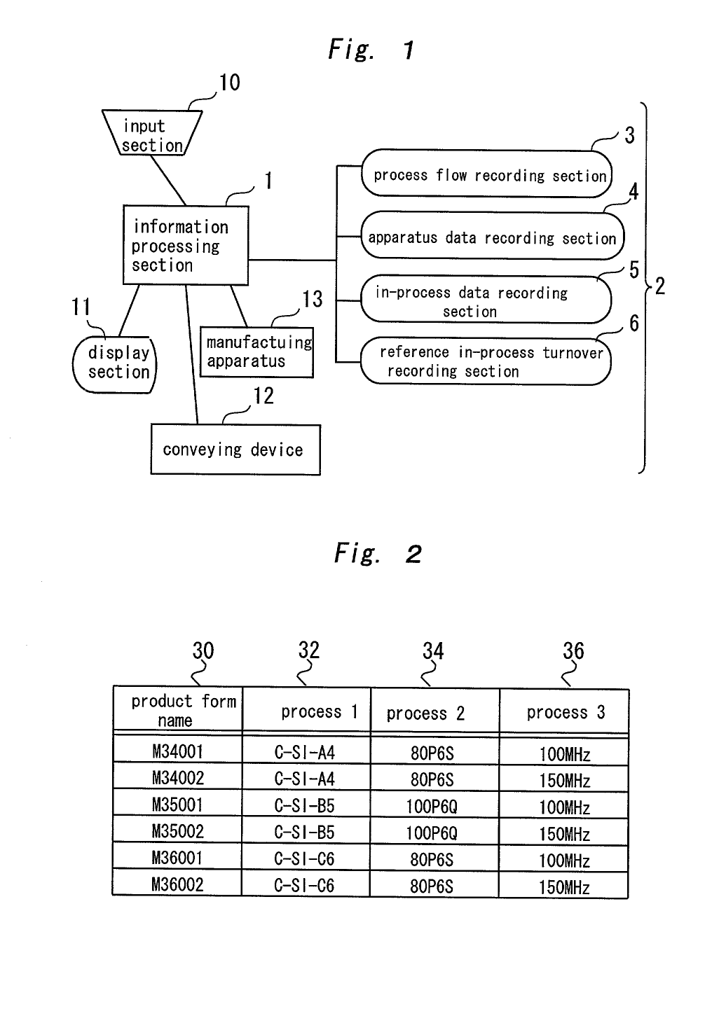

FIG. 2 shows the contents of the process flow recording section 3 shown in FIG. 1. As shown in FIG. 2, the process flow recording section 3 comprises a product form name column 30 showing identifiers such as the names of processed products or the names of a product form, a process 1 column 32 which is indicative, for each product form name, of the manufacturing apparatus 13 used for a process 1, a process 2 column 34 which is indicative, for each product form name, of the manufacturing apparatus 13 used for a process 2, and a process 3 column 36 which is indicative, for each product form name, of the manufacturing apparatus 13 used for a process 3. FIG. 2 illustrates only the three processes, but this is for explanatory clarity and the number of processes is not limited.

As shown in FIG. 2, the products or processed products shown in the product form name column 30 advance sequentially through the processes starting with the process 1. Information on the group of manufacturing apparatuses 13 used for each process is recorded for each product form name. For example, products with the product form name “M34001” are processed by the manufacturing apparatus 13 named “C-SI-A4” during the process 1, then by the manufacturing apparatus 13 named “80P6S” during the process 2, and finally by the manufacturing apparatus 13 operating at “100 MHz” during the process 3.

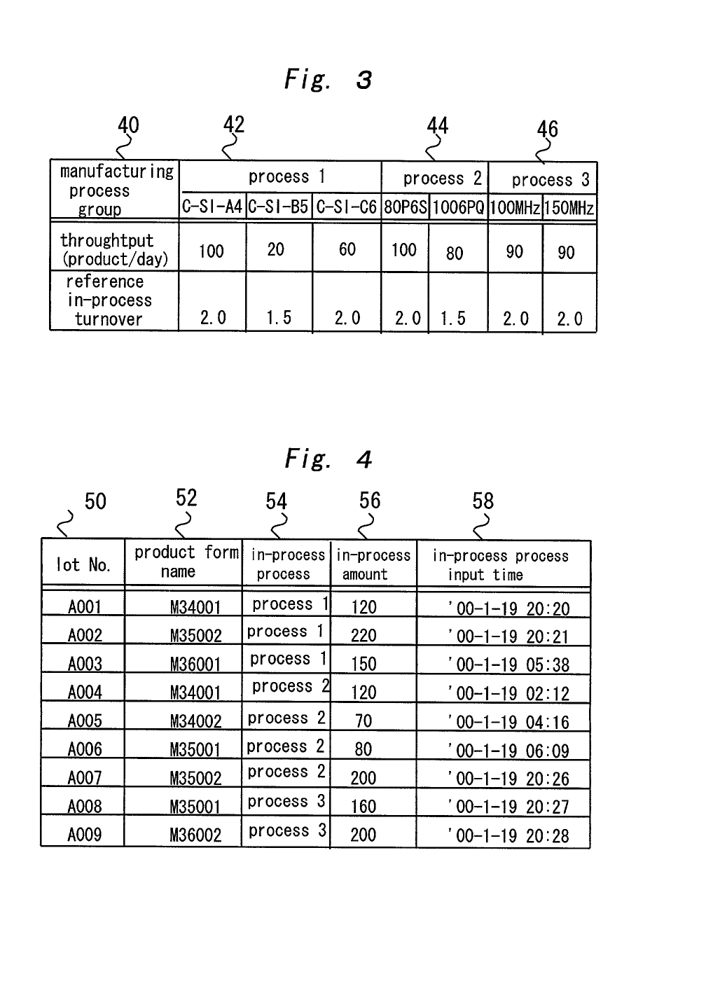

FIG. 3 shows the contents of a combination of the apparatus data recording section 4 and reference in-process turnover recording section 6 shown in FIG. 1. As shown in FIG. 3, these sections comprise a manufacturing process group column 40 showing the throughput (the number of processed products that can be processed per day) and reference in-process turnover of the manufacturing apparatus 13, a process 1 column 42 showing the throughput and reference in-process turnover of the manufacturing apparatus 13 used for the process 1, a process 2 column 44 showing the throughput and reference in-process turnover of the manufacturing apparatus 13 used for the process 2, and a process 3 column 46 showing the throughput and reference in-process turnover of the manufacturing apparatus 13 used for the process 3. As shown in this figure, the throughput and reference in-process turnover are recorded for each process and for each group of manufacturing apparatuses. For example, the “C-SI-A4”, one of the manufacturing apparatuses 13 used for the process 1 can process 100 works per day and has a reference in-process turnover of 2.0. FIG. 3 illustrates only the three processes, but this is for explanatory clarity and the number of processes is not limited. Although FIG. 3 shows the configuration comprising the contents of the combination of the apparatus data recording section 4 and reference in-process turnover recording section 6, theses sections may, of course, be separated from each other.

FIG. 4 shows the contents of the in-process data recording section 5 shown in FIG. 1. As shown in FIG. 4, this section comprises lot No. column 50 containing the name or identifier of each lot, a product form name column 52 showing identifiers such as processed product names or product form names, an in-process process column 54 showing the current in-process processes, an in-process amount column 56 showing the current in-process amount, and an in-process process input time column 58 showing a date and time when the lot shown in the lot No. column 50 was input to the in-process process shown in the in-process process column 54. The in-process process input time column 58 may be separated from the others. For example, the lot with the lot number “A001” belongs to the product form name “M34001”, is in the “process 1”, yields “120” products, and was input to the process 1 at “'00-1-19, 20:20 (indicating 20:20 on Jan. 19, 2000).

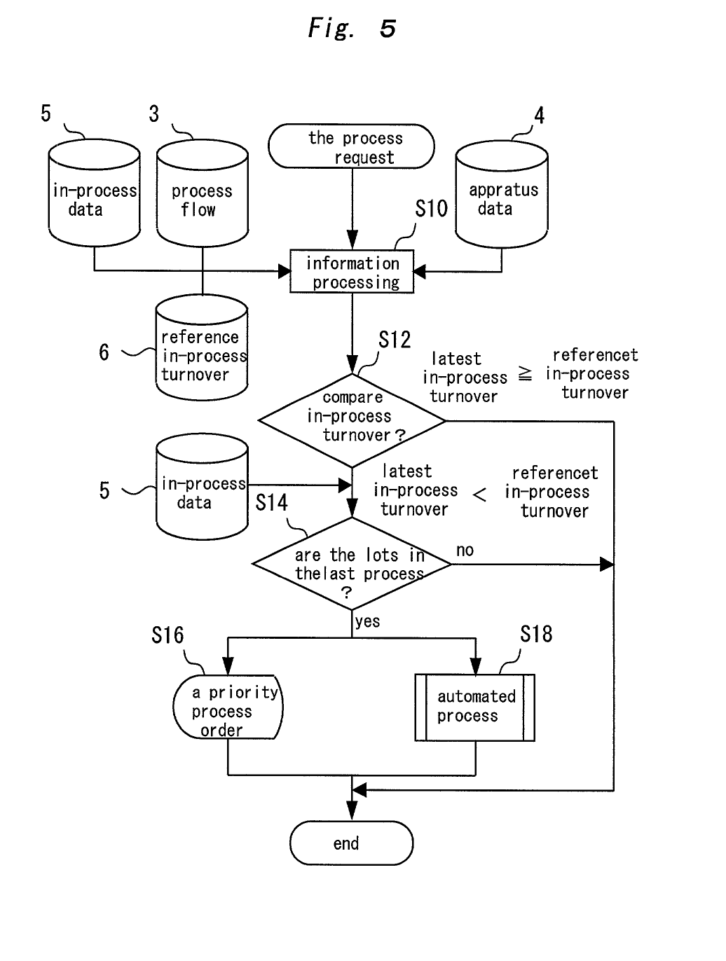

FIG. 5 is a flow chart showing a distribution controlling method according to the embodiment of the present invention. Those parts in FIG. 5 which, are denoted by the same reference numerals as those in FIG. 1 denote the same components, and description thereof is thus omitted. As shown in FIG. 5, the flow chart showing the distribution controlling method shows that lots are selected from the in-process lots for each group of manufacturing apparatuses 13 using the recording sections shown in FIG. 1, particularly, the data or the like shown in FIGS. 2 to 4.

When a process request is issued, data are passed to the information processing section 1 from the process flow recording section 3, the apparatus data recording section 4, the in-process data recording section 5, and the reference in-process turnover recording section 6. The information processing section 1 calculates the latest in-process turnover for each group of manufacturing apparatuses using Equation (1) (step S10).

[Equation 1]

Latest in-process turnover=latest in-process amount÷throughput (1)

For example, a description will be made of the four lots with the lot numbers “A004” to “A007” which are in the “process 2” as shown in the in-process process column 54 in FIG. 4. These lots belong to the product form names “M34001” , “M34002”, “M35001”, and “M35002” and are processed during the “process 2” by the manufacturing apparatuses “80P6S”, “80P6S”, “100P6Q”, and “100P6Q” as shown in FIG. 2. Then, the in-process amounts shown in the in-process amount column 56 are shown below for each manufacturing apparatus 13.

Lot number “A004”: group of manufacturing apparatuses “80P6S” and in-process amount “120”

Lot number “A005”: group of manufacturing apparatuses “80P6S” and in-process amount “70”

Lot number “A006”: group of manufacturing apparatuses “100P6Q” and in-process amount “80”

Lot number “A007”: group of manufacturing apparatuses “100P6Q” and in-process amount “200”

The group of manufacturing apparatuses “80P6S” have a latest in-progress amount of 190 (=120+70) and a throughput of 100 as shown in the process 2 column 44 in FIG. 3. Consequently, the latest in-process turnover is 190÷100=1.9 based on Equation (1). On the other hand, the group, of manufacturing apparatuses “100P6Q” have a latest in-progress amount of 280 (=80+200) and a throughput of 80 as shown in the process 2 column 44 in FIG. 3. Consequently, the latest in-process turnover is 280÷80=3.5 based on Equation (1) (step S10).

Next, the latest in-process turnover is compared with the reference in-process turnover in FIG. 3 (step S12). In the above described example, since the group of manufacturing apparatuses “80P6S” have a reference in-process turnover of 2.0, 1.9<2.0, that is, the latest in-process turnover is smaller than the reference in-process turnover. Accordingly, a process request must be made to a process (process 1) preceding the process 2. On the other hand, since the group of manufacturing apparatuses “100P6Q” have a reference in-process turnover of 1.5, 3.5>1.5, that is, the latest in-process turnover is larger than the reference in-process turnover. Accordingly, a process request must not be made to a process (process 1) preceding the process 2 (step S12).

If the latest in-process turnover is smaller than the reference in-process turnover at step S12, it is checked whether the processed product lots corresponding to the group of manufacturing apparatuses “80P6S” are in the last process (process 1) (step S14). Specifically, the three lots which are in the “process 1” as shown in the in-process process column 54 in FIG. 4 have lot numbers from “A001” to “A003”, and these lots contain product form names “M34001”, “M35002” and “M36001”, respectively. As shown in FIG. 2, the group of manufacturing apparatuses “80P6S” is used for the processed products with the product form name “M34001” during the process 2, the group of manufacturing apparatuses “80P6S” is used for the processed products with the product form name “M35002” during the process 2, and the group of manufacturing apparatuses “₈₀P6S” is used for the processed products with the product form name “M36001” during the process 2. It is thus found that the group of manufacturing apparatuses “80P6S” is used for two of the above three lots which have the lot numbers “A001” and “A003” (step S14).

Further, to make a priority process request only for a required amount, a throughput required amount is calculated based on the reference in-process turnover, the throughput, and the latest in-process amount, using Equation (2) (step S16).

[Equation 2]

Process request required amount=reference in-process turnover×throughput−latest in-process amount (2)

In the above described example, the process request required amount is determined as 2.0×100−190=10. On the other hand, the lot number “A001” has an in-process amount of 120 and the lot number “A003” has an in-process amount of 150, a priority process must be requested only for one of the lots. If such a priority process can be requested for a plurality of lots, the priority request is issued for a lot which was input to the in-process process earliest. For example, the in-process process input time column 58 in FIG. 4 shows that the lot with the lot number “A001” was input to the in-process process at “′00-1-19, 20:20 (indicative of 20:20 on Jan. 19, 2000)” and that the lot with the lot number “A003” was input to the in-process process at “′00-1-19, 05:38 (indicative of 5:38 on Jan. 19, 2000)”. Consequently, the lot with the lot number “A003”, which is in the process 1, is a priority request lot for the group of manufacturing apparatuses “80P6S” (step S16).

These results of processing can be communicated to an operator or the like via a display section 1. Alternatively, in an automated process, a computer (not shown) controlling conveyance can be instructed to execute automatic conveyance, as shown in FIG. 5 (step S18).

As described above, according to the present embodiment, the reference in-process turnover for each group of manufacturing apparatuses enables the priority process request to be made to the last process so that a higher priority is given to those of the group of processed products being processed by the current group of manufacturing apparatuses which flow to a group of manufacturing apparatuses having an in-process turnover smaller than the reference in-process turnover during the next process. As a result, despite the control of the entire process in the factory, each group of manufacturing apparatuses are always prevented from waiting for products, thus enabling the capabilities of the manufacturing apparatuses to be maximized. Consequently, manufacturing periods and inventory properties can be reduced. Furthermore, the systemization serves to save labor and increase process speeds.

A method for manufacturing a semiconductor device can also be provided which method uses the above described present distribution controlling apparatus. In this case, for example, the processed products are semiconductor devices and the manufacturing apparatus is an apparatus for manufacturing a semiconductor device. According to the method for manufacturing a semiconductor device using the present distribution controlling apparatus, the reference in-process turnover for each group of semiconductor manufacturing apparatuses enables the priority process request to be made to the last process so that a higher priority is given to those of the group of semiconductor devices being processed by the current group of semiconductor manufacturing apparatuses which flow to a group of semiconductor manufacturing apparatuses having an in-process turnover smaller than the reference in-process turnover during the next process. As a result, despite the control of the entire process in the factory, each group of semiconductor manufacturing apparatuses are always prevented from waiting for products, thus enabling the capabilities of the semiconductor manufacturing apparatuses to be maximized. Consequently, manufacturing periods and inventory properties can be reduced. Furthermore, the systemization serves to save labor and increase process speeds.

As described above, according to the distribution controlling apparatus and method and the method for manufacturing a semiconductor device, the reference in-process turnover for each group of manufacturing apparatuses enables the priority process request to be made to the last process so that a higher priority is given to those of the group of processed products being processed by the current group of manufacturing apparatuses which flow to a group of manufacturing apparatuses having an in-process turnover smaller than the reference in-process turnover during the next process. The present invention can thus provide a distribution controlling apparatus and method and a method for manufacturing a semiconductor device wherein the current and last processes can be linked together and wherein a system for controlling distribution can be easily operated.

In the distribution controlling apparatus, the priority process request presented by the priority request presenting means may be indicative of a process request required amount obtained by multiplying the temporary reference in-process turnover by the throughput and subtracting the latest in-process turnover from a value obtained by the multiplication.

In the distribution controlling apparatus, the in-process data recording section may further have an input time recorded therein for each lot, the input time being indicative of a time at which the lot was input to an in-process process, and if a plurality of lots are present to which the priority request is to be presented, the priority request presenting means presents the priority request to a lot which was input at the earliest time.

In the distribution controlling apparatus, if the latest in-process turnover may be not smaller than the reference in-process turnover, the priority request presenting means does not present the priority request.

In the distribution controlling method, the priority process request presented by the priority request presenting step may be indicative of a process request required amount obtained by multiplying the temporary reference in-process turnover by the throughput and subtracting the latest in-process turnover from a value obtained by the multiplication.

In the distribution controlling method, the in-process data recording section may further have an input time recorded therein for each lot, the input time being indicative of a time at which the lot was input to an in-process process, and if a plurality of lots are present to which the priority request is to be presented, the priority request presenting step presents the priority request to a lot which was input at the earliest time.

In the distribution controlling method, if the latest in-process turnover may be not smaller than the reference in-process turnover, the priority request presenting means does not present the priority request.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

The entire disclosure of Japanese Patent Application No. 2001-5461 filed on Jan. 12, 2001 including specification, claims, drawings and summary are incorporated herein by reference in its entirety.

What is claimed is:

1. A distribution controlling apparatus comprising:
a process flow recording section having identifiers of processed products and identifiers of manufacturing apparatuses recorded therein for each process, the manufacturing apparatuses processing the processed products;
a reference in-process turnover recording section having a throughput and a reference in-process turnover of each manufacturing apparatus recorded therein for each process, the throughput being indicative of the amount of processed products that can be processed by a manufacturing apparatus during a predetermined period, the reference in-process turnover being indicative of a ratio between an in-process amount of a process and the throughput;
an in-process data recording section having a lot number, an identifier of processed products in the lot, an in-process process for the lot, and a latest in-process amount during the in-process process recorded therein for each lot;
latest in-process turnover calculating means for reading from said in-process data recording section the identifiers of processed products in lots which are in a predetermined in-process process, reading from said process flow recording section identifiers of manufacturing apparatuses corresponding to the identifiers of the processed products which are in the predetermined in-process process, adding the latest in-process amount to lots which are in the predetermined in-process process and which have the identifier of the same manufacturing apparatus, reading from said reference in-process turnover recording section the throughput corresponding to the identifier of the manufacturing apparatus operating during the predetermined in-process process, and dividing the latest in-process amount obtained through the addition, by the throughput to determine a latest in-process turnover; and
priority request presenting means for reading from said reference in-process turnover recording section the reference in-process turnover corresponding to the identifier of the manufacturing apparatus operating during the predetermined in-process process, and if the latest in-process turnover determined by said latest in-process turnover calculating means is smaller than the reference in-process turnover, presenting a priority process request for lots which are in a process before the predetermined in-process process and for which the manufacturing apparatus is used during the predetermined process.

2. The distribution controlling apparatus according to claim 1, wherein the priority process request presented by said priority request presenting means is indicative of a process request required amount obtained by multiplying said temporary reference in-process turnover by said throughput and subtracting said latest in-process turnover from a value obtained by the multiplication.

3. The distribution controlling apparatus according to claim 2, wherein said in-process data recording section further has an input time recorded therein for each lot, the input time being indicative of a time at which the lot was input to an in-process process, and if a plurality of lots are present to which the priority request is to be presented, said priority request presenting means presents the priority request to a lot which was input at the earliest time.

4. The distribution controlling apparatus according to claim 1, wherein said in-process data recording section further has an input time recorded therein for each lot, the input time being indicative of a time at which the lot was input to an in-process process, and if a plurality of lots are present to which the priority request is to be presented, said priority request presenting means presents the priority request to a lot which was input at the earliest time.

5. The distribution controlling apparatus according to claim 1, wherein if said latest in-process turnover is not smaller than said reference in-process turnover, said priority request presenting means does not present the priority request.

6. A distribution controlling method using:
a process flow recording section having identifiers of processed products and identifiers of manufacturing apparatuses recorded therein for each process, the manufacturing apparatuses processing the processed products;
a reference in-process turnover recording section having a throughput and a reference in-process turnover of each manufacturing apparatus recorded therein for each process, the throughput being indicative of the amount of processed products that can be processed by a manufacturing apparatus during a predetermined period, the reference in-process turnover being indicative of a ratio between an in-process amount of a process and the throughput; and
an in-process data recording section having a lot number, an identifier of processed products in the lot, an in-process process for the lot, and a latest in-process amount during the in-process process recorded therein for each lot, the method comprising the steps of:
a latest in-process turnover calculating step of reading from said in-process data recording section the identifiers of processed products in lots which are in a predetermined in-process process, reading from said process flow recording section identifiers of manufacturing apparatuses corresponding to the identifiers of the processed products which are in the predetermined in-process process, adding the latest in-process amount to a lot which is in the predetermined in-process process and which has the identifier of the same manufacturing apparatus, reading from said reference in-process turnover recording section the throughput corresponding to the identifier of the manufacturing apparatus operating during the predetermined in-process process, and dividing the latest in-process amount obtained through the addition, by the throughput to determine a latest in-process turnover; and
a priority request presenting step of reading from said reference in-process turnover recording section the reference in-process turnover corresponding to the identifier of the manufacturing apparatus operating during the predetermined in-process process, and if the latest in-process turnover determined by said latest in-process turnover calculating step is smaller than the reference in-process turnover, presenting a priority process request for lots which are in a process before the predetermined in-process process and for which the manufacturing apparatus is used for the predetermined process.

7. The distribution controlling method according to claim 6, wherein the priority process request presented by said priority request presenting step is indicative of a process request required amount obtained by multiplying said temporary reference in-process turnover by said throughput and subtracting said latest in-process turnover from a value obtained by the multiplication.

8. The distribution controlling method according to claim 7, wherein said in-process data recording section further has an input time recorded therein for each lot, the input time being indicative of a time at which the lot was input to an in-process process, and if a plurality of lots are present to which the priority request is to be presented, said priority request presenting step presents the priority request to a lot which was input at the earliest time.

9. The distribution controlling method according to claim 6, wherein said in-process data recording section further has an input time recorded therein for each lot, the input time being indicative of a time at which the lot was input; to an in-process process, and if a plurality of lots are present to which the priority request is to be presented, said priority request presenting step presents the priority request to a lot which was input at the earliest time.

10. The distribution controlling method according to claim 6, wherein if said latest in-process turnover is not smaller than said reference in-process turnover, said priority request presenting means does not present the priority request.

11. A method for manufacturing a semiconductor device, the method using the distribution controlling apparatus set forth in any of claims 1 to 5.
